(19) United States
(12) Patent Application Publication
(10) Pub. No.: US 2009/0010169 A1
(43) Pub. Date: Jan. 8, 2009

(54) PACKET TRANSFER APPARATUS AND METHOD FOR TRANSMITTING COPY PACKET

(76) Inventors: Kazuyuki TAMURA, Yokohama (JP); Teruo Kaganoi, Funabashi (JP); Yohei Kondo, Hadano (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/146,011

(22) Filed: Jun. 25, 2008

(30) Foreign Application Priority Data
Jul. 3, 2007 (JP) 2007-175281
May 14, 2008 (JP) 2008-127251

(51) Int. Cl. H04L 12/26; H04L 29/02

(52) U.S. Cl. 370/241; 370/464

(57) ABSTRACT

A packet transfer apparatus includes a data analyzing unit, a memory control unit, and a control unit that holds a copy condition table and has a control information comparing unit. The data analyzing unit refers to a header of a received packet to analyze control information and transmits an analysis result to the control unit. The control unit searches the copy condition table on the basis of the analysis result and transmits a search result to the memory control unit. The memory control unit generates a record of a copy packet whose packet length is shortened in a memory calling management table on the basis of the search result.

### CLAIM OF PRIORITY

The present application claims priority from Japanese patent application serial nos. 2007-175281 and 2008-127251, filed on Jul. 3, 2007, and May 14, 2008, the contents of which are hereby incorporated by reference into this application.

### BACKGROUND OF THE INVENTION

The present invention relates to a packet transfer apparatus for transferring a packet received from a network, and a method for transmitting a copy packet.

In a general packet transfer apparatus such as a router/switch, mirroring is one of functions for supporting analysis of network traffic. The mirroring is a function for transmitting a copy of a packet to be transmitted or received to a specified physical port. Reception of the mirrored packet by an analyzer enables monitoring or analysis of traffic.

JP-A-2005-301766 describes a relay apparatus which performs mirroring on the basis of information from a movement monitoring system.

JP-A-2006-148898 describes a copying/shortening technique for a packet in a particular format used in a specific protocol.

JP-A-11-068791 describes a technique by which in order to improve transmission efficiency of an ATM transmission path, plural cells having the same cell headers are accumulated and are transmitted while eliminating the cell headers except for a first cell header.

In “AX7800R/AX7700R Software Manual”, Applications Guide, Vol. 2, ALAXALA Networks, pp. 207 to 212, a port monitoring function and specifications are described, and a brief explanation of mirroring is further described.

In the technique of “AX7800R/AX7700R Software Manual”, Applications Guide, Vol. 2, ALAXALA Networks, pp. 207 to 212, a bandwidth that can be monitored in mirroring is determined depending on the bandwidth of a physical port from which a copy packet is output. In order to perform mirroring for two ports each with a gigabit bandwidth, it is necessary to prepare two ports each with a gigabit bandwidth to transmit the copy packet. Therefore, when a bandwidth to be monitored is higher than that of a port for outputting a copy packet, it is necessary to prepare an appropriate physical port for output of the copy packet. In addition, when the bandwidth of the port to be monitored is higher than that of the preparable port for outputting the copy packet, some packets fail to be transmitted in some cases.

### SUMMARY OF THE INVENTION

The above-described problem can be solved by a packet transfer apparatus including means for copying a received packet or a transmission packet, wherein the means for copying copies an original packet by eliminating a part of the original packet and shortening the length of the packet.

Moreover, the above-described problem can be solved by a packet transfer apparatus, including: a reception processing unit; a transfer unit including a data analyzing unit and a memory control unit; and a control unit that holds a copy condition table and has a control information comparing unit, wherein the data analyzing unit refers to a header of a packet received from the reception processing unit to analyze control information and transmits an analysis result to the control unit, the control unit searches the copy condition table on the basis of the analysis result and transmits a search result to the memory control unit, and the memory control unit generates a record of a copy packet whose packet length is shortened in a memory calling management table on the basis of the search result.

Further, the above-described problem can be solved by a packet transfer apparatus, including: a reception processing unit; a transfer unit including a data analyzing unit and a memory control unit; and a control unit that holds a copy condition table and has a control information comparing unit, wherein the control unit obtains a search condition from the copy condition table and transmits the search condition to the data analyzing unit, the data analyzing unit refers to a packet received from the reception processing unit to analyze on the basis of the search condition and transmits an analysis result to the memory control unit, and the memory control unit generates a record of a copy packet whose packet length is shortened in a memory calling management table on the basis of the analysis result.

Moreover, the above-described problem can be solved by a method for transmitting a copy packet, including: a step of referring to a header of a received packet to analyze control information; a step of searching a copy condition table on the basis of an analysis result; a step of generating a record of a copy packet whose packet length is shortened in a memory calling management table on the basis of a search result; and a step of transmitting the copy packet.

Furthermore, the above-described problem can be solved by a method for transmitting a copy packet, including: a step of referring to a copy condition table to obtain a search condition; a step of referring to a received packet on the basis of an obtained result to obtain a search result under the search condition; a step of generating a record of a copy packet whose packet length is shortened in a memory calling management table on the basis of the search result; and a step of transmitting the copy packet.

### BRIEF DESCRIPTION OF THE DRAWINGS

Preferred embodiments of the present invention will now be described in conjunction with the accompanying drawings, in which:

FIG. 1 is a block diagram of a packet transfer apparatus;

FIG. 2 is a detailed block diagram of a transfer unit and a control unit of the packet transfer apparatus;

FIG. 3 is a diagram explaining a received-packet copy condition table;

FIG. 4 is a diagram explaining a transmission-packet copy condition table;

FIGS. 5A and 5B are diagrams explaining frame formats of a relay packet and a copy packet;

FIG. 6 is a diagram explaining a memory reading table;

FIG. 7 is a detailed block diagram of the transfer unit, the control unit, and a line interface unit;

FIG. 8 is a diagram explaining a packet copy condition table;

FIG. 9 is a diagram explaining another packet copy condition table;

FIG. 10 is a diagram explaining still another packet copy condition table;

FIG. 11 is a block diagram of a packet transfer apparatus employing a dispersion-type switching system;

FIG. 12 is a diagram explaining still another packet copy condition table;

FIGS. 13A and 13B are diagrams explaining frame formats of the relay packet and another copy packet;

FIG. 14 shows still another packet copy condition table;

FIGS. 15A and 15B are diagrams explaining frame formats of the relay packet and another copy packet;

FIG. 16 is a block diagram explaining a configuration of a network;

FIG. 17 shows still another packet copy condition table;

FIG. 18 is a diagram explaining an analyzer flow list;

FIG. 19 is a diagram explaining an input command to an SW;

FIG. 20 is a block diagram explaining a configuration of an operation ID management system;

FIGS. 21A to 21C show formats of Ethernet frames and a copy frame used in the operation ID management system;

FIG. 22 is a diagram explaining still another packet copy condition table;

FIG. 23 is a diagram explaining an analyzer flow list; and

FIG. 24 is a diagram explaining an input command to an SW.

### DESCRIPTION OF THE PREFERRED EMBODIMENTS

Hereinafter, embodiments of the present invention will be described with reference to the drawings. It should be noted that substantially the same constituent elements are given the same reference numeral and the description thereof will not be repeated.

### First Embodiment

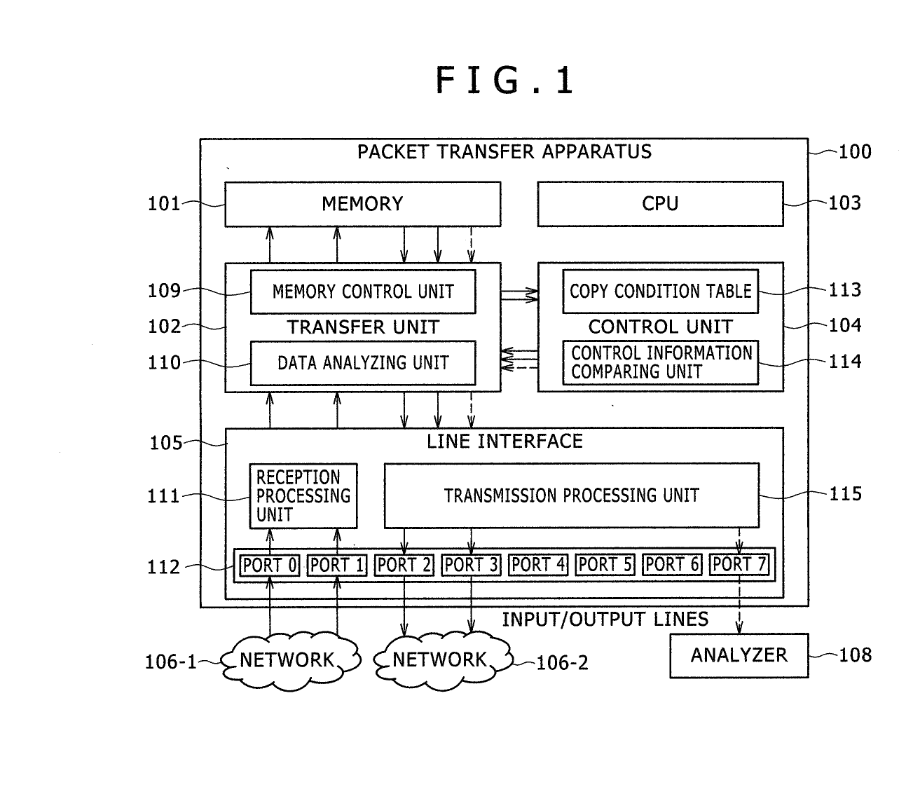

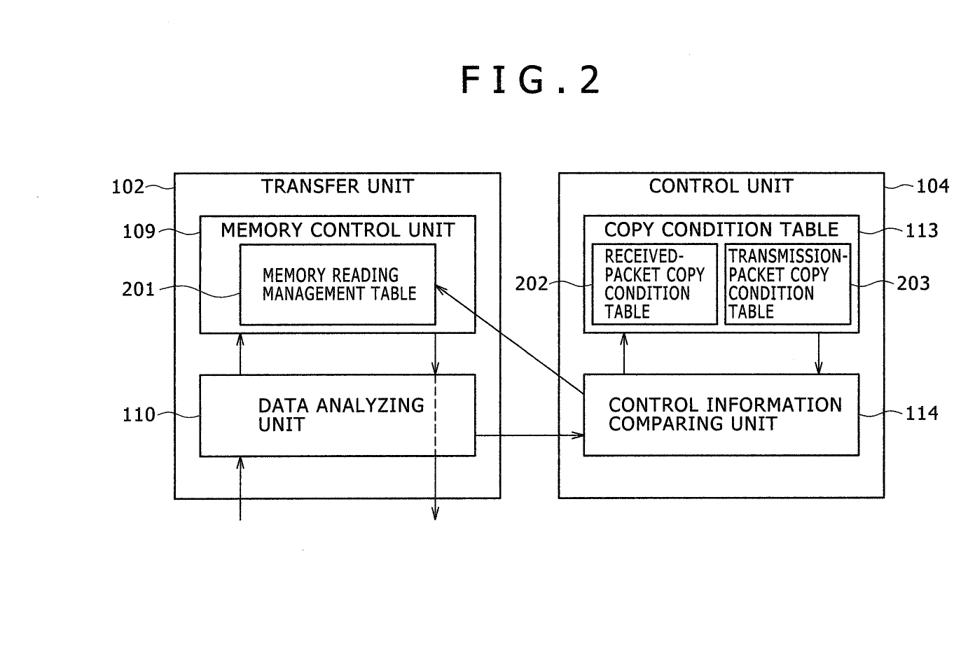

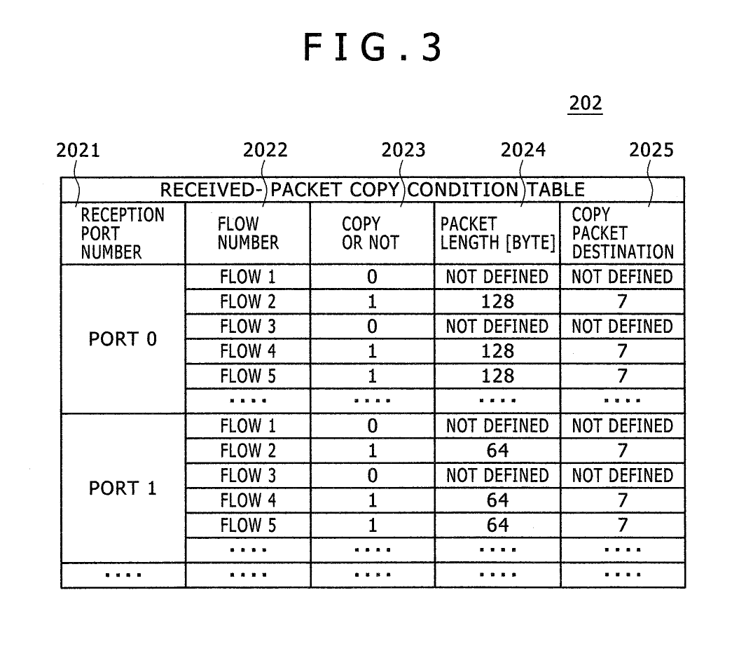

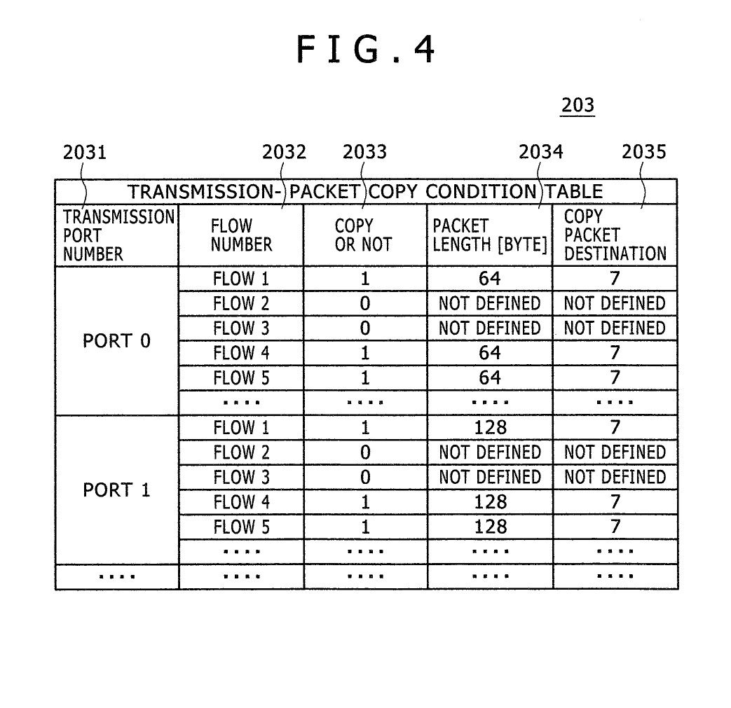

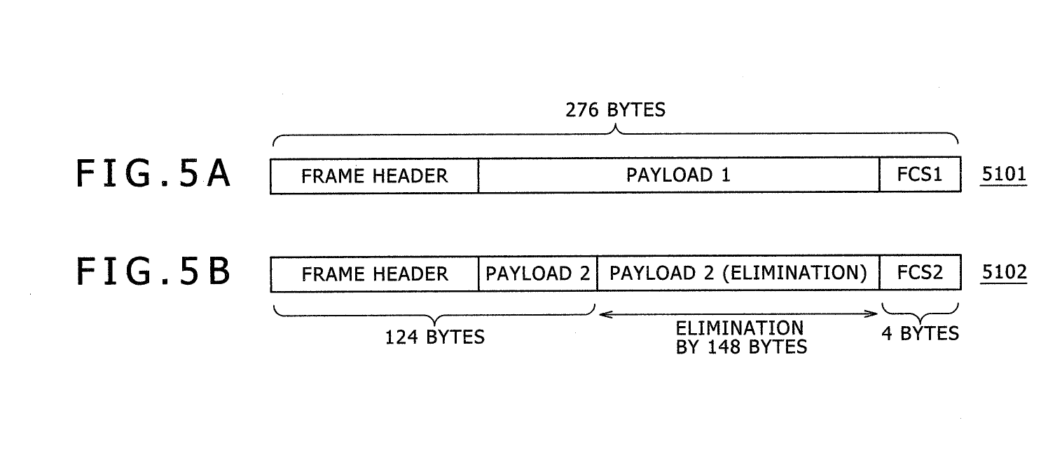

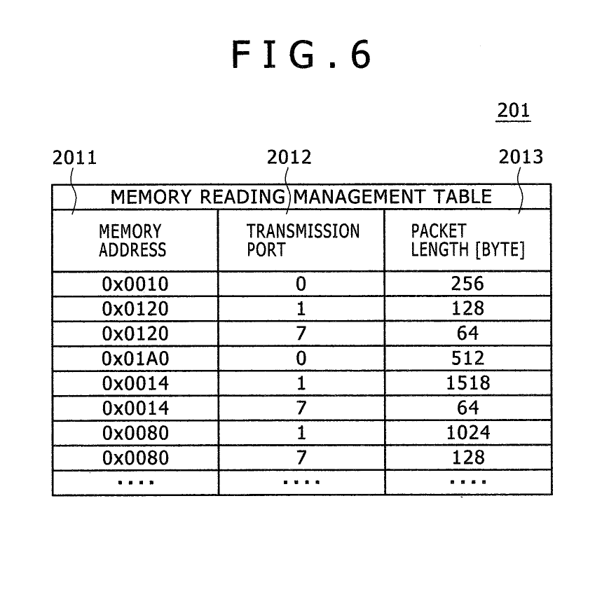

A first embodiment will be described with reference to FIGS. 1 to 6. FIG. 1 is a block diagram of a packet transfer apparatus. FIG. 2 is a detailed block diagram of a transfer unit and a control unit of the packet transfer apparatus. FIG. 3 is a diagram explaining a received-packet copy condition table. FIG. 4 is a diagram explaining a transmission-packet copy condition table. FIGS. 5A and 5B are diagrams explaining frame formats of a relay packet and a copy packet. FIG. 6 is a diagram explaining a memory reading table.

In FIG. 1, a packet transfer apparatus 100 includes a line interface 105 which accommodates external lines to perform a transmission/reception process for a packet, a transfer unit 102 which writes and reads a transmission/received packet into/from a memory 101, analyzes control information included in each received packet and notifies a control unit 104 of the control information, the control unit 104 which determines a method of processing the packet on the basis of the control information of each received packet, and a CPU 103 which executes a program to control the whole apparatus.

The line interface 105 includes a transmission/reception port unit 112 with 8 ports (a port 0 to a port 7 from the left side to the right side), a reception processing unit 111, and a transmission processing unit 115. The transfer unit 102 includes a data analyzing unit 110 which analyzes transmission/received data and a memory control unit 109 which controls reading/writing of data from/into the memory 101. The control unit 104 includes a control information comparing unit 114 and a copy condition table 113.

The port 0 and the port 1 of the transmission/reception port unit 102 are connected to a network 106-1 to receive data. The port 2 and the port 3 are connected to a network 106-2 to receive data. The port 7 is connected to an analyzer 108 to transfer mirrored data.

In FIG. 2, the memory control unit 109 of the transfer unit 102 includes a memory reading management table 201. In addition, the copy condition table 113 of the control unit 104 includes a received-packet copy condition table 202 and a transmission-packet copy condition table 203. The data analyzing unit 110 analyzes the control information of each packet while referring to a header field of each packet input from the ports 0 to 6. The data analyzing unit 110 notifies the control unit 104 of the analysis result. Packet data pieces themselves are stored into the memory 101 from the data analyzing unit 110 through the memory control unit 109.

The control unit 104 allows the control information comparing unit 114 to compare the analysis result of the control information notified from the transfer unit 102 with the copy condition table 113. When the received packet is copied, the control unit 104 refers to the received-packet copy condition table 202 on the basis of a reception port number and a flow number notified from the data analyzing unit 110. On the other hand, when the transmission packet is copied, the control unit 104 refers to the transmission-packet copy condition table 203 on the basis of a transmission port number and a flow number determined by the control unit 104. The control unit 104 notifies the memory control unit 109 of the analysis result such as “copy or not”, “packet length” and “destination” indicated in a line corresponding to the reception port number or the transmission port number.

In FIG. 3, the received-packet copy condition table 202 includes a reception port number 2021, a flow number 2022, a “copy or not” 2023, a packet length 2024, and a copy packet destination 2025. “0” in the “copy or not” 2023 indicates that the packet is not to be copied, and “1” indicates that the packet is to be copied. The packet length 2024 is defined when the packet is to be copied, and the length of the packet to be copied is written thereinto. A destination of the copy packet is written into the copy packet destination 2025, and the port 7 to which the analyzer 108 is connected is written thereinto in the embodiment.

In FIG. 4, the transmission-packet copy condition table 203 includes a transmission port number 2031, a flow number 2032, a “copy or not” 2033, a packet length 2034, and a copy packet destination 2035. “0” in the “copy or not” 2033 indicates that the packet is not to be copied, and “1” indicates that the packet is to be copied. The packet length 2034 is defined when the packet is to be copied, and the length of the packet to be copied is written thereinto. A destination of the copy packet is written into the copy packet destination 2035, and the port 7 to which the analyzer 108 is connected is written thereinto in the embodiment.

In FIGS. 5A and 5B, when the length of the relay packet in FIG. 5A is 276 bytes, a 128-byte copy packet shown in FIG. 5B is generated by adding Frame Check Sequence (FCS) of a 4-byte Cycle Redundancy Check (CRC) code computed on the basis of 124 bytes from the top of the relay packet to the 124 bytes. In the case of a 64-byte copy packet, the FCS of the 4-byte CRC code computed on the basis of 60 bytes from the top of the relay packet is added to the 60 bytes. The selection of the 4-byte FCS allows the analyzer 108 to check garbled bits in a transmission path on reception of the copy packet.

The packet length of the copy packet is shortened by the method shown in the embodiment, so that it is possible to apply to all packets flowing on the network without limiting to a packet in a specific format. Further, the packet a part of which is eliminated has the same format as a normal Ethernet frame, so that it is possible to relay the packet and analyze the packet information with a general packet transfer apparatus and a general network analyzer.

In FIG. 6, the memory reading management table 201 includes a memory address 2011, a transmission port 2012, and a packet length 2013. In the memory reading management table 201, each record in which “7” is written in the transmission port 2012 is a record of the copy packet. Each record with the same memory address as that of the copy packet is a record of the relay packet. When reading the copy packet, the packet length is read while subtracting the 4-byte FCS from the packet length written in the corresponding record. Then, CRC is computed to be added to the read packet length, and the resultant packet is transmitted from the port 7.

Referring to FIG. 2 again, the transfer unit 102 registers the comparison result from the control unit 104 into the memory reading management table 201 included in the memory control unit 109. The transfer unit 102 reads the data from the memory on the basis of the information of the table 201.

Referring to FIG. 1 again, the transfer unit 102 reads the data from the memory and transmits the read data to the transmission processing unit 115 from the memory control unit 109. The transmission processing unit 115 transmits the read data from a specified port.

### Second Embodiment

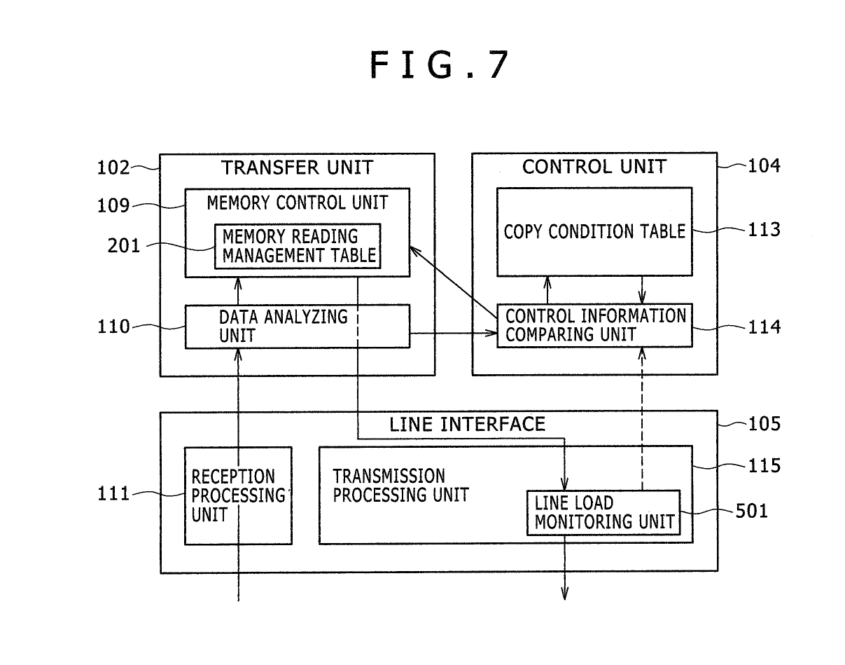

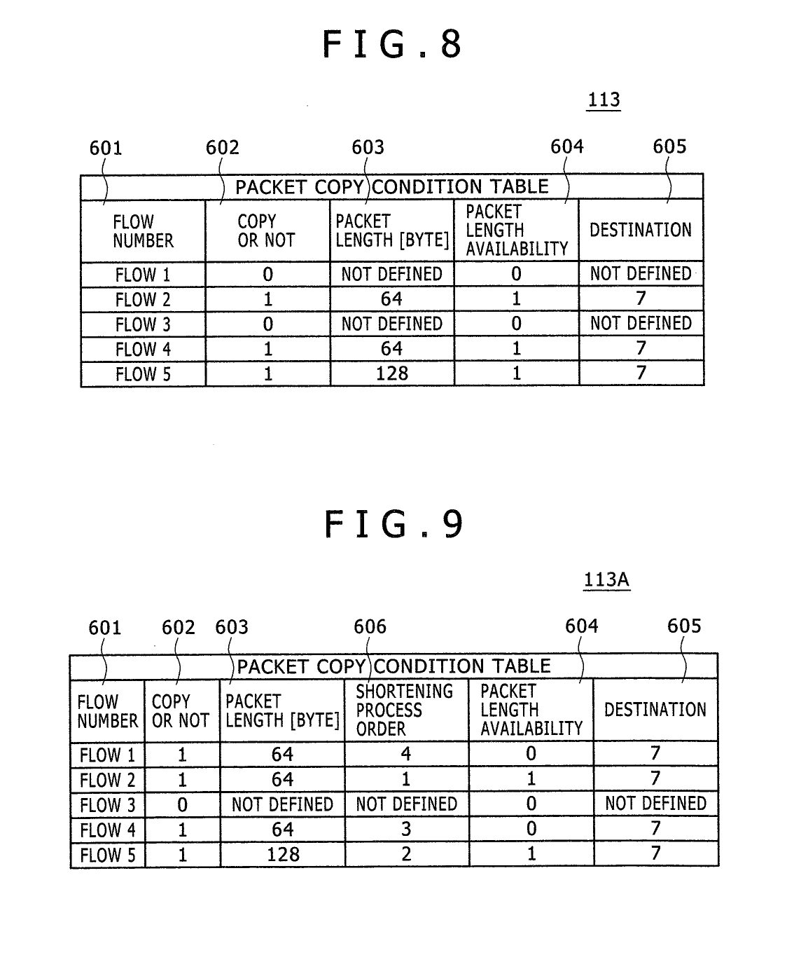

A second embodiment will be described with reference to FIGS. 7 and 8. FIG. 7 is a detailed block diagram of the transfer unit, the control unit, and the line interface unit. FIG. 8 is a diagram explaining the packet copy condition table. It should be noted that the packet copy condition table only for the port 0 will be shown in the second and following embodiments for simply illustrating the table.

In FIG. 7, the packet transfer apparatus explained using FIG. 1 is further provided with a line load monitoring unit 501 in the transmission processing unit of the line interface. The line load monitoring unit 501 monitors the load status of the port 7 connected to an analyzer (not shown), and notifies the control information comparing unit in the control unit of the load status. Specifically, the line load monitoring unit 501 sets a constant threshold bandwidth at the port 7 from which the copy packet is output. When a usage bandwidth at the port 7 exceeds the threshold bandwidth, the line load monitoring unit 501 notifies the control information comparing unit 114 of the fact that the usage bandwidth exceeds the threshold bandwidth.

In FIG. 8, when the transmission processing unit 115 is provided with the line load monitoring unit 501, the packet copy condition table 113 included in the control unit 104 includes a flow number 601, a “copy or not” 602, a packet length 603, a packet length availability 604, and a destination 605. As being apparent from the comparison with FIGS. 3 and 4, the packet length availability 604 is newly added to the packet copy condition table 113.

The packet length availability 604 is a parameter for determining whether or not the copy packet is actually transmitted with the packet length registered in the packet length 603 on the basis of the notification result from the line load monitoring unit 501. Specifically, in the case where the usage bandwidth at the port 7 from which the copy packet is output is increased and the line load monitoring unit 501 notifies the control information comparing unit 114 of the fact that the usage bandwidth exceeds the threshold bandwidth, “1” is registered in the packet length availability 604. When “1” is registered in the packet length availability 604, the copy process for the packet is performed using the packet length registered in the packet length 603. When “0” is registered in the packet length availability 604, the packet length registered in the packet length 603 is disabled, so as to perform the copy process using the packet length same as the original packet.

A modified embodiment of the second embodiment will be described with reference to FIG. 9. FIG. 9 is a diagram explaining another packet copy condition table. In FIG. 9, when the transmission processing unit 115 is provided with the line load monitoring unit 501, a packet copy condition table 113A included in the control unit 104 includes a flow number 601, a “copy or not” 602, a packet length 603, a packet length availability 604, a destination 605, and a shortening process order 606. As being apparent from the comparison with FIG. 8, the shortening process order 606 is newly added to the packet copy condition table 113A.

The shortening process order 606 indicates the order of turning a flag on in the packet length availability 604 on the basis of the notification result from the line load monitoring unit 501. Specifically, in the case where the line load monitoring unit 501 notifies the control information comparing unit 114 of the fact that the usage bandwidth exceeds the threshold bandwidth, the flag of the packet length availability 604 in the flow 2 having the smallest registration number of the shortening process order 606 is set to “1”. In the case where the notification is still continued thereafter, the flag of the packet length availability 604 in the flow 5 having the second smallest registration number of the shortening process order 606 is set to “1”. On the contrary, in the case where the notification of the exceeding of the threshold bandwidth is stopped, the flag of the packet length availability 604 is turned to “0” from the flow having the largest number of the shortening process order.

The above description is one embodiment of a method for enabling the limitation of the packet length. In the case where the notification of the exceeding of the threshold bandwidth is present, it is possible to uniformly enable the limitation of the packet length only for a part of flows registered in advance.

### Third Embodiment

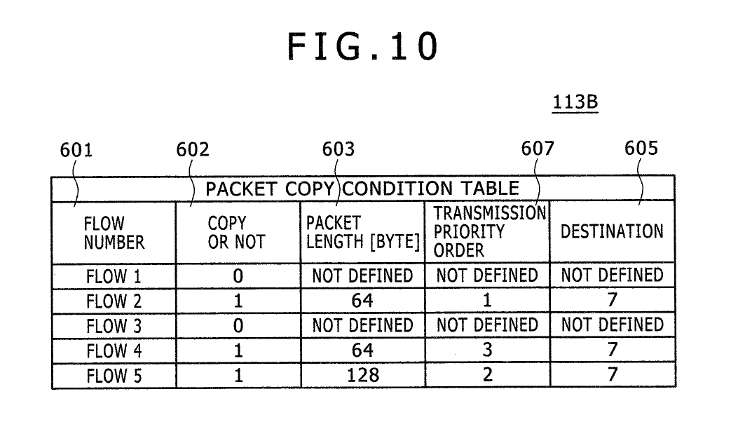

A third embodiment will be described with reference to FIG. 10. FIG. 10 is a diagram explaining still another packet copy condition table. In FIG. 10, a packet copy condition table 113B included in the control unit 104 includes a flow number 601, a “copy or not” 602, a packet length 603, a destination 605, and a transmission priority order 607.

In FIG. 10, the transmission priority orders 607 of the flows 2, 5, and 4 are defined as “1”, “2”, and “3”, respectively, in the packet transfer apparatus shown in FIG. 1. As a result, the copy packet of the flow 2 is given priority for transmission. Therefore, even when the usage bandwidth at the output port for the copy packet is increased and some copy packets fail to be transmitted, it is possible to reliably transmit the copy packet in the flow 2 with the high priority.

### Fourth Embodiment

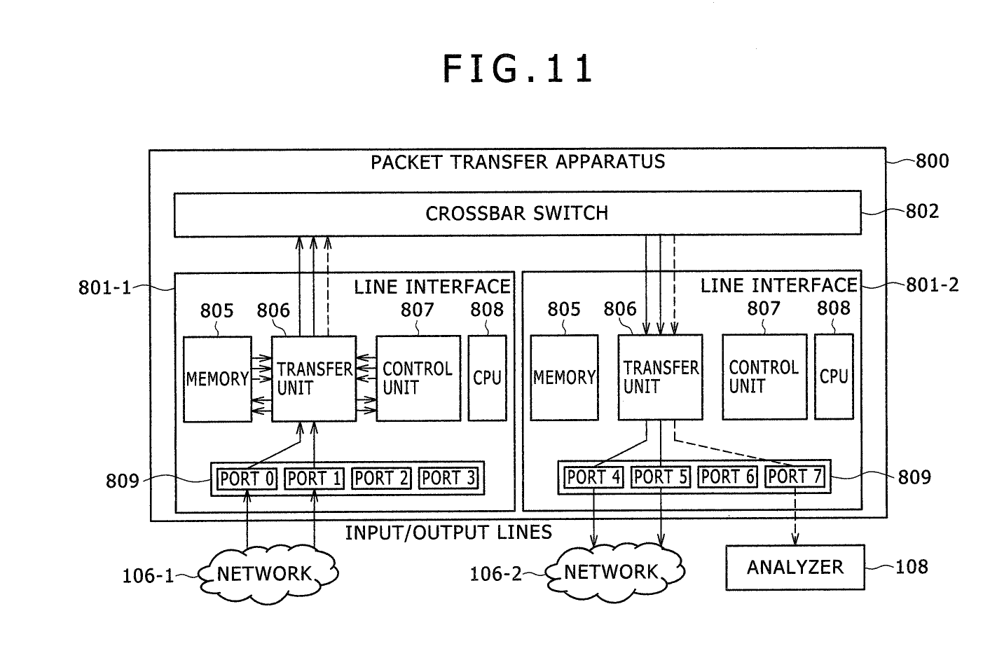

A fourth embodiment will be described with reference to FIG. 11. FIG. 11 is a block diagram of a packet transfer apparatus employing a dispersion-type switching system. In FIG. 11, a packet transfer apparatus 800 includes a line interface 801-1 connected to a network 106-1, a line interface 801-2 connected to a network 106-2, and a crossbar switch 802. In addition, each of the line interfaces 801 includes a transmission/reception port unit 809 connected to the network 106, a transfer unit 806 connected to the transmission/reception port unit 809 and the crossbar switch 802, a memory 805, a control unit 807, and a CPU 808. Ports of the line interface 801-1 are referred to as ports 0 to 3, and ports of the line interface 801-2 are referred to as ports 4 to 7. An analyzer 108 is connected to the port 7.

In the fourth embodiment, the packet transfer apparatus 800 has the transfer unit 806 and the control unit 807 for each line interface 801, and the crossbar switch 802 bundles the respective line interfaces 801. Even in the packet transfer apparatus 800, the procedure of generating the copy packet is basically the same as those explained in FIGS. 1 to 10. However, in the case where the packet which is received by the line interface 801-1 to be transferred to the line interface 801-2 is mirrored, the copy packet generated by the line interface 801-1 is usually transferred to the crossbar switch 802 together with the transferred packet. Specifically, a hardware resource of the crossbar switch 802 is shared by the normal packet and the copy packet. By shortening the packet length of the copy packet using the fourth embodiment, it is possible to reduce a resource necessary for transferring the copy packet in the crossbar switch 802 and to minimize the improper effect on the transfer of the normal packet caused by the mirroring.

### Fifth Embodiment

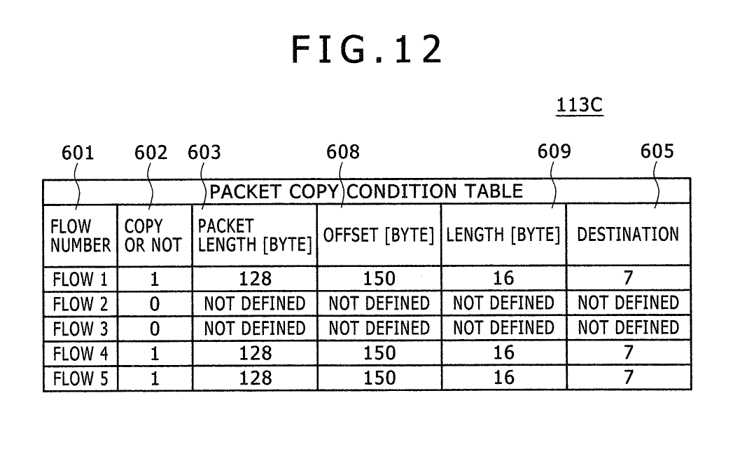

A fifth embodiment will be described with reference to FIGS. 12, 13A and 13B. FIG. 12 is a diagram explaining still another packet copy condition table. FIGS. 13A and 13B are diagrams explaining frame formats of the relay packet and another copy packet. It should be noted that items only for the port 0 are extracted and shown in FIG. 12.

In FIG. 12, a packet copy condition table 113C includes a flow number 601, a “copy or not” 602, a packet length 603, an offset 608, a length 609, and a destination 605. As being apparent from the comparison with FIGS. 3 and 4, the offset 608 and the length 609 are newly added to the packet copy condition table 113C. In addition to the packet length which is fixedly copied, when another field is additionally copied, the offset 608 defines its starting point. The length 609 defines the length of the field to be copied from the position defined in the offset 608.

In FIGS. 13A and 13B, FIG. 13A is a format of the relay packet with a packet length of 276 bytes. The copy packet with 144 bytes shown in FIG. 13B corresponds to the flow 1 in FIG. 12, and includes a “frame header” and a “payload 1” located within a range of 124 bytes from the top of the relay packet shown in FIG. 13A, a “payload 3” located in a 16-byte field ranging from the position apart from the top of the relay packet by 150 bytes to the position apart from the top of the relay packet by 166 bytes, and a FCS2 of a 4-byte CRC code computed using data with 140 bytes of the frame header, the payload 1, and the payload 3.

Specifically, the copy packet is generated by adding the FCS2 to the field with a length obtained by subtracting the 4-byte FCS from the value defined in the packet length 603 from the top of the relay packet and the field ranging from the position apart by the length defined in the offset 608 to the position ahead by the length defined in the length 609.

By shortening the packet length of the copy packet in the fifth embodiment, not only the top portion of the packet, but also an arbitrary field of the packet can be copied.

### Sixth Embodiment

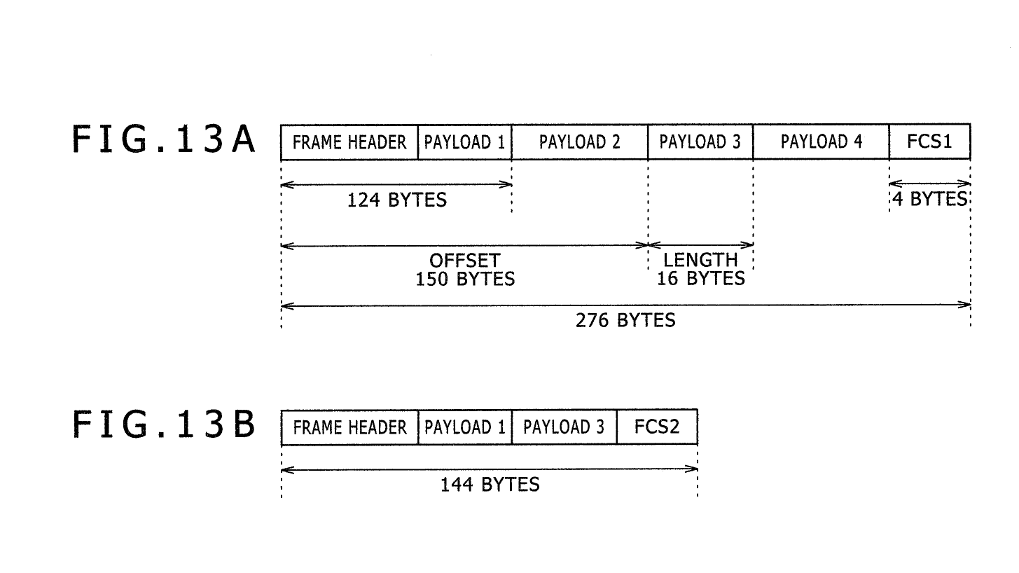

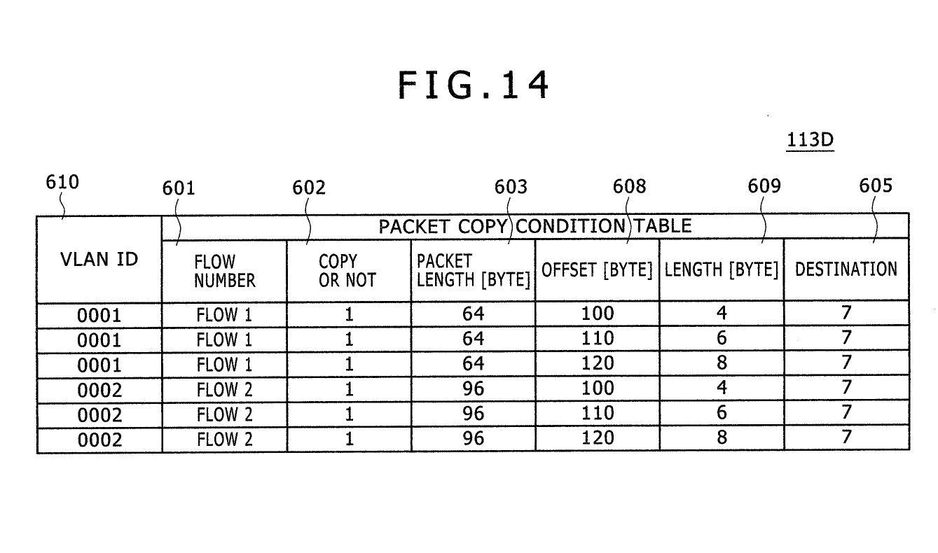

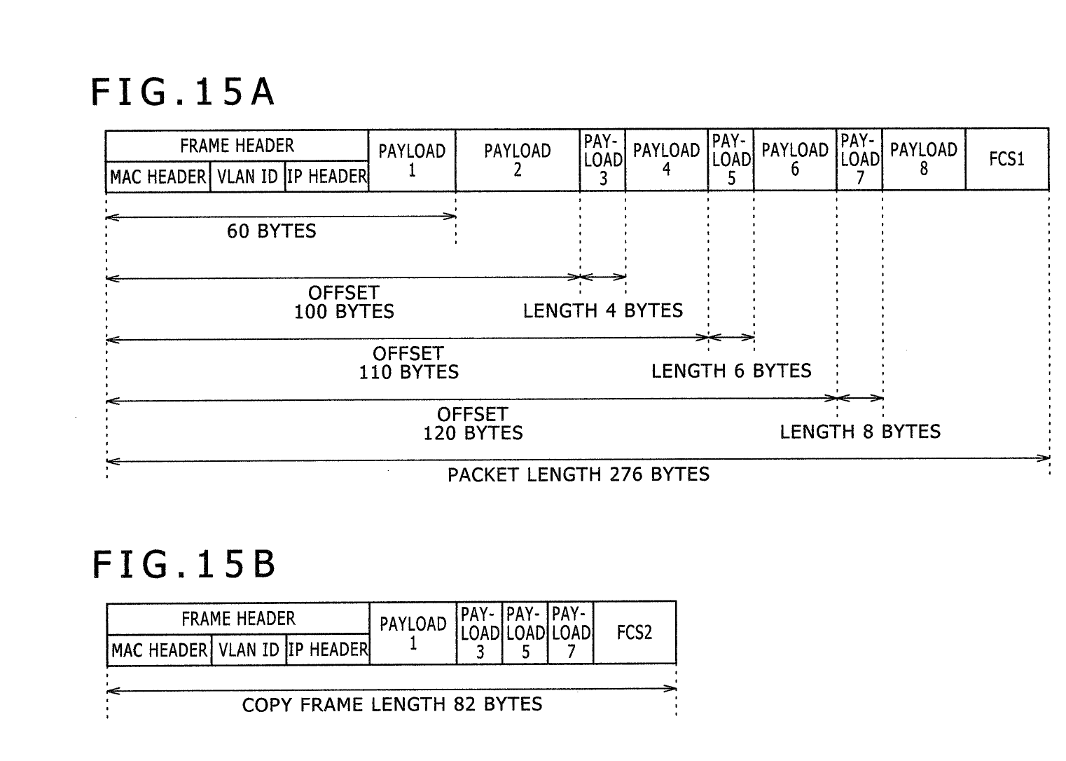

A sixth embodiment will be described with reference to FIGS. 14, 15A and 15B. FIG. 14 shows still another packet copy condition table. FIGS. 15A and 15B are diagrams explaining frame formats of the relay packet and another copy packet.

In FIG. 14, a column “VLANID 610” is added as a discriminating condition of a flow in a packet copy condition table 113D. The flow number 601 is defined in such a manner that the value of VLANID given to the relay packet is referred to, so that the flow number corresponds to the value. In addition, plural copy conditions are set per one flow in the packet copy condition table 113D.

A method of generating a copy packet in a flow where plural copy conditions are defined per one flow will be described. The packet transfer apparatus copies data with the length defined in the packet length 603 from the top of the relay packet. However, in the case of a flow in which plural copy conditions are set, the packet length 603 at the top of the table is applied. Next, the data with the length defined in the length 609 from the position defined in the off set 608 are sequentially copied under the conditions starting from one at the top of the table.

This process will be described in more detail using FIGS. 15A and 15B. It is assumed in FIGS. 15A and 15B that as the VLANID, “0001” is given to the relay packet and the relay packet is a packet corresponding to the flow 1 in the packet copy condition table 113D shown in FIG. 14. FIG. 15A is a format of the relay packet with a packet length of 276 bytes. The copy packet with 82 bytes shown in FIG. 15B includes a “frame header” and a “payload 1” located within a range of 60 bytes from the top of the relay packet shown in FIG. 15A, a “payload 3” located within a range from the position apart from the top of the relay packet by 100 bytes to the position apart from the top of the relay packet by 104 bytes, a “payload 5” located within a range from the position apart from the top of the relay packet by 110 bytes to the position apart from the top of the relay packet by 116 bytes, a “payload 7” located within a range from the position apart from the top of the relay packet by 120 bytes to the position apart from the top of the relay packet by 128 bytes, and the FCS2 of a 4-byte CRC code computed using data with 78 bytes of the frame header, the payload 1, the payload 3, the payload 5, and the payload 7.

Specifically, the copy packet is generated by adding the FCS to the field with a length obtained by subtracting the 4-byte FCS from the value (the value of the packet length 603 registered on the uppermost side of the table in the case where plural copy conditions are defined for a single flow) defined in the packet length 603 from the top of the relay packet and the field (in the case where plural copy conditions are defined for a single flow, the registered copy conditions are sequentially applied from the top) ranging from the position apart by the length defined in the offset 608 to the position ahead by the length defined in the length 609.

By shortening the packet length of the copy packet in the sixth embodiment, plural arbitrary fields in the packet can be copied. In the case where plural copy conditions are defined for a single flow, a positive integral number is defined in the packet length 603 registered on the uppermost side of the table, and 0 may be defined in the packet length 603 as the other records of the copy conditions.

The VLANID is used as the discriminating condition of the flow in the sixth embodiment. However, a source MAC address or a source IP address may be used but not limited thereto.

### Seventh Embodiment

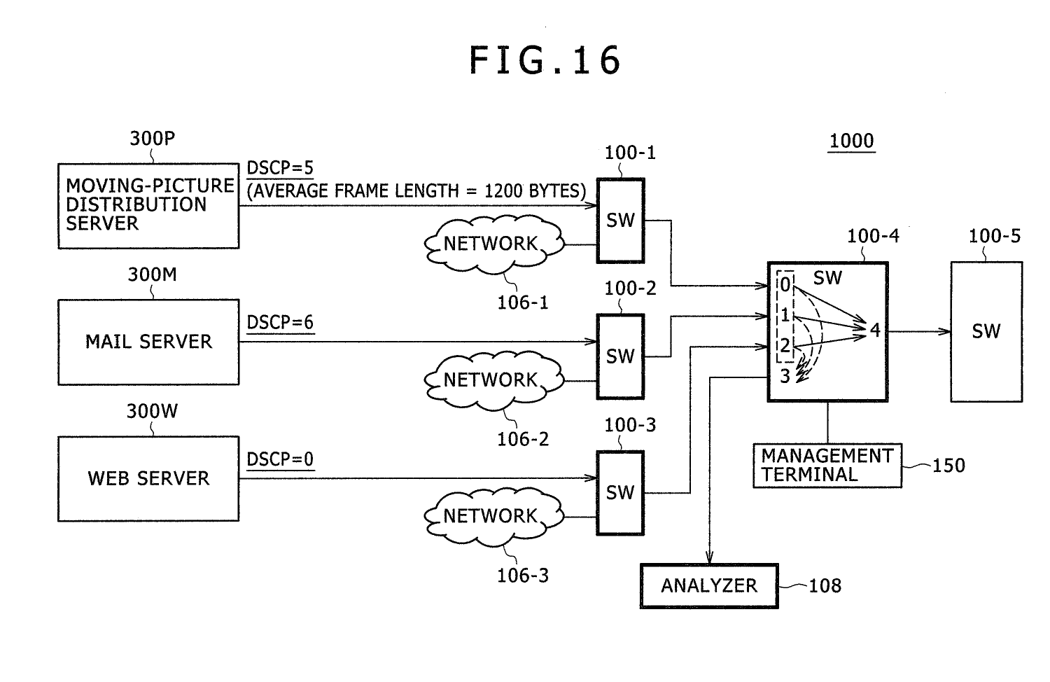

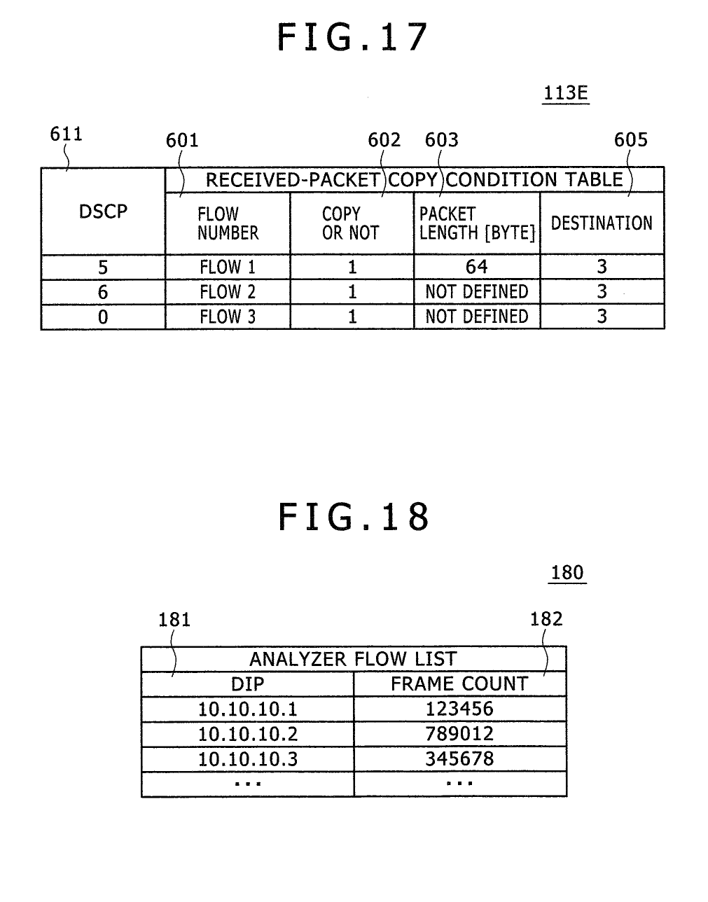

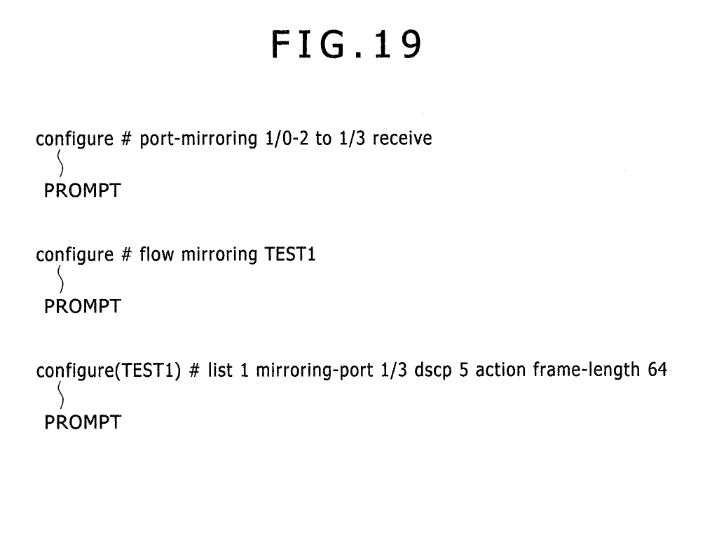

A seventh embodiment will be described with reference to FIGS. 16 to 19. FIG. 16 is a block diagram explaining a configuration of a network. FIG. 17 shows still another packet copy condition table. FIG. 18 is a diagram explaining an analyzer flow list. FIG. 19 is a diagram explaining an input command to an SW.

In FIG. 16, a network 1000 includes five SWs 100, a moving-picture distribution server 300P and a network 106-1 connected to an SW 100-1, a mail server 300M and a network 106-2 connected to an SW 100-2, a Web server 300W and a network 106-3 connected to an SW 100-3, and an analyzer 108 connected to a port 3 of an SW 100-4.

The SW 100-1 is connected to a port 0 of the SW 100-4. The SW 100-2 is connected to a port 1 of the SW 100-4. The SW 100-3 is connected to a port 2 of the SW 100-4. An SW 100-5 is connected to a port 4 of the SW 100-4. Further, a management terminal 150 is connected to the SW 100-4.

All of the SWs 100-1 to 100-5 are packet transfer apparatuses. The SW 100-1 accommodates the moving-picture distribution server and the network 106-1, the SW 100-2 accommodates the mail server and the network 106-2, and the SW 100-3 accommodates the Web server and the network 106-3.

It is assumed that values “5” and “6” are embedded into Differentiated Services Code Point (DSCP) fields of headers of packets transmitted from the moving-picture distribution server and the mail server, respectively, by applications of the respective servers. It should be noted that a value “0” is usually embedded into the DSCP field. The SW 100-4 accommodates the SWs 100-1 to 100-3 at the ports 0 to 2, respectively. The SW 100-4 refers to the DSCP fields of packets that are further input to sort the respective packets into the three flows of the flow 1, the flow 2, and the flow 3. Here, the packet whose DSCP field is “5” and which is transmitted from the moving-picture distribution server 300P is assigned to the flow 1, the packet whose DSCP field is “6” and which is transmitted from the mail server 300M is assigned to the flow 2, and another packet including a packet transmitted from the Web server 300W is assigned to the flow 3.

There will be described a case in which Destination IP Addresses (hereinafter, abbreviated as DIPs) of all packets that pass through the SW 100-4 are checked by using a mirroring function mounted in the SW 100-4. The SW 100-4 copies the packets input to the ports 0 to 2, and outputs the copy packets from the port 3. The analyzer 108 collects the copy packets. However, when a total bandwidth of the ports 0 to 2 exceeds the physical bandwidth of the port 3, a part of the copy packets is discarded in the SW 100-4.

The DIP field is located at the position apart from the top (MAC header) of the packet by 30 bytes. Specifically, copying of only 60 bytes (the shortest length of the Ethernet frame excluding the FCS) from the top of the packet sufficiently collects the DIPs of the respective packets.

Moving picture traffic generally contains many packets each with a long packet length, and occupies a broad bandwidth. In the network 1000 of FIG. 16, an average packet length in the traffic transmitted from the moving-picture distribution server 300P is 1200 bytes.

The SW 100-4 has a received-packet copy condition table shown in FIG. 17. In FIG. 17, a received-packet copy condition table 113E includes a DSCP 611, a flow number 601, a “copy or not” 602, a packet length 603, and a destination 605. The received-packet copy condition table 113E is set in such a manner that the copy packets in the flows 1 to 3 are transmitted to the port 3, and the packet length of the copy packet in the flow 1 is shortened to 64 bytes. It should be noted that items only for the port 0 are extracted and shown in FIG. 17.

In FIG. 18, an analyzer flow list 180 shows the number of frames held by the analyzer 108, and includes a DIP 181 and a frame count 182. The analyzer 108 analyzes the DIP field of the received copy packet to search the DIP 181, and increments the frame count 182 of the corresponding record.

Character User Interface (CUI) of the management terminal will be described with reference to FIG. 19. In FIG. 19, “configure #” in the first line is a prompt. “Port-mirroring 1/0-2 to 1/3 receive” defines a slot number and a port number of an original port in mirroring and a slot number and a port number of a destination port in mirroring. A file name of “TEST1” is defined in the second line. “Configure (TEST1) #” in the third line is a prompt. “Mirror-port 1/3” is defined as “list1” for a destination port in mirroring. When “5” is found in the DSCP field, the frame length is shortened to “frame-length 64” for transfer.

Accordingly, the mirror traffic used in the flow 1 can be eliminated by about 95% {(1200-64)/1200}, the number of packets discarded in the SW 100-4 can be sufficiently reduced.

### Eighth Embodiment

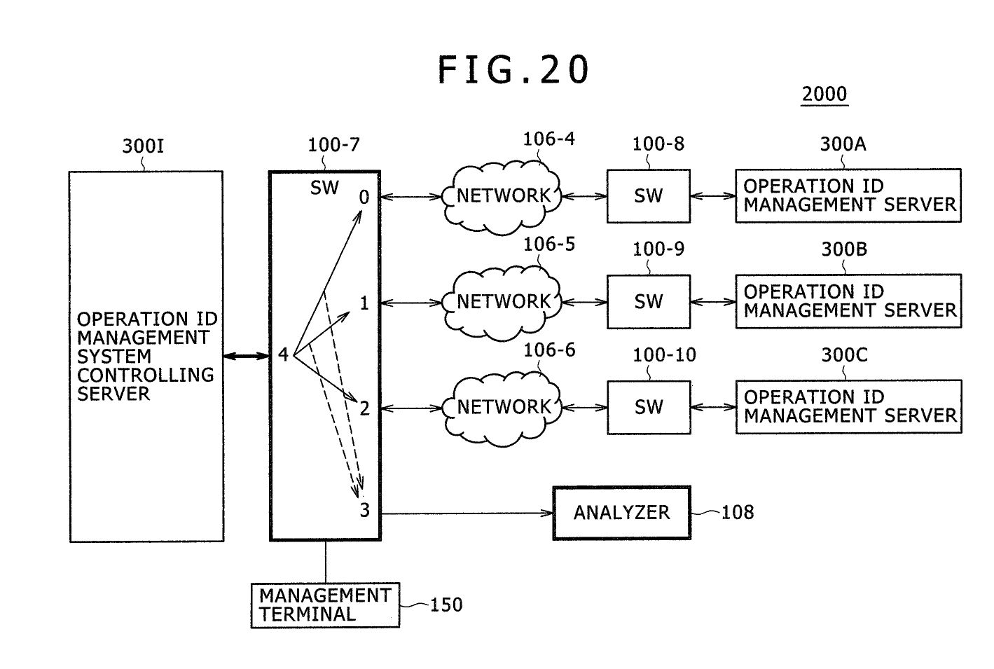

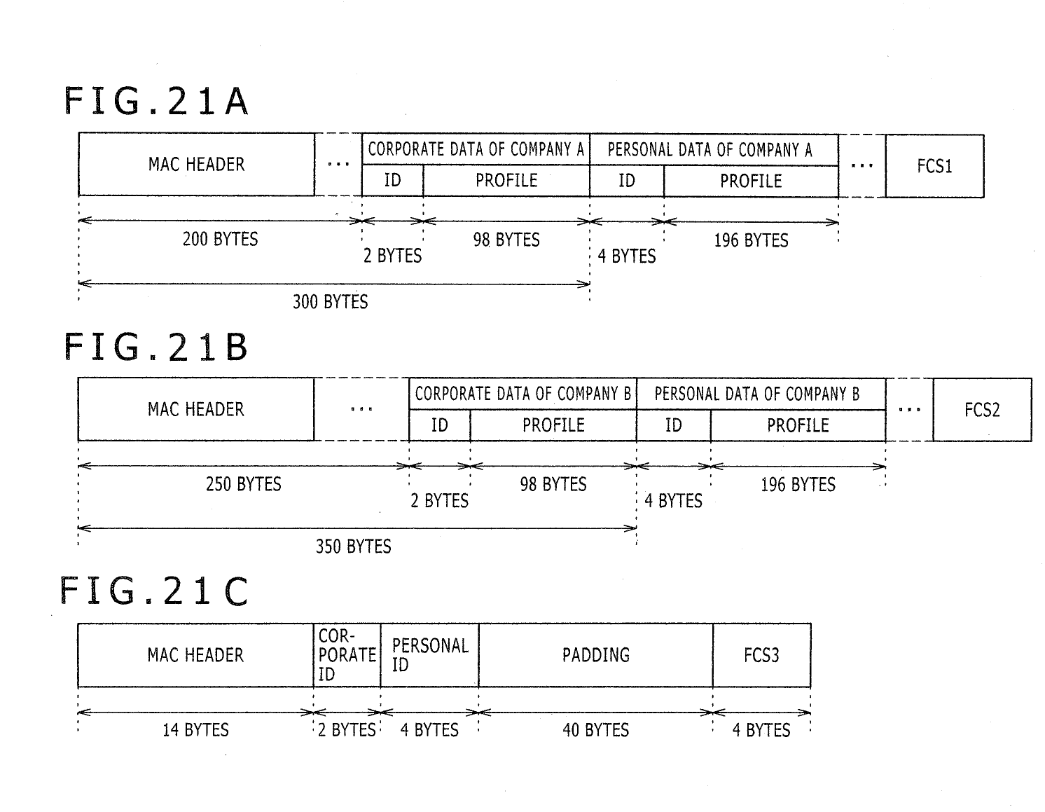

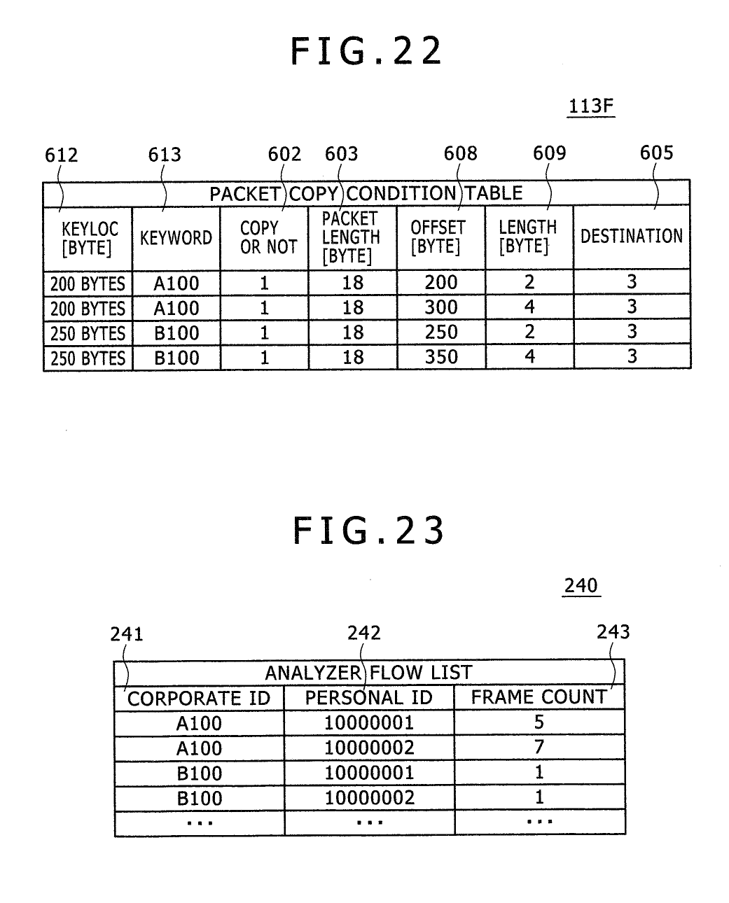

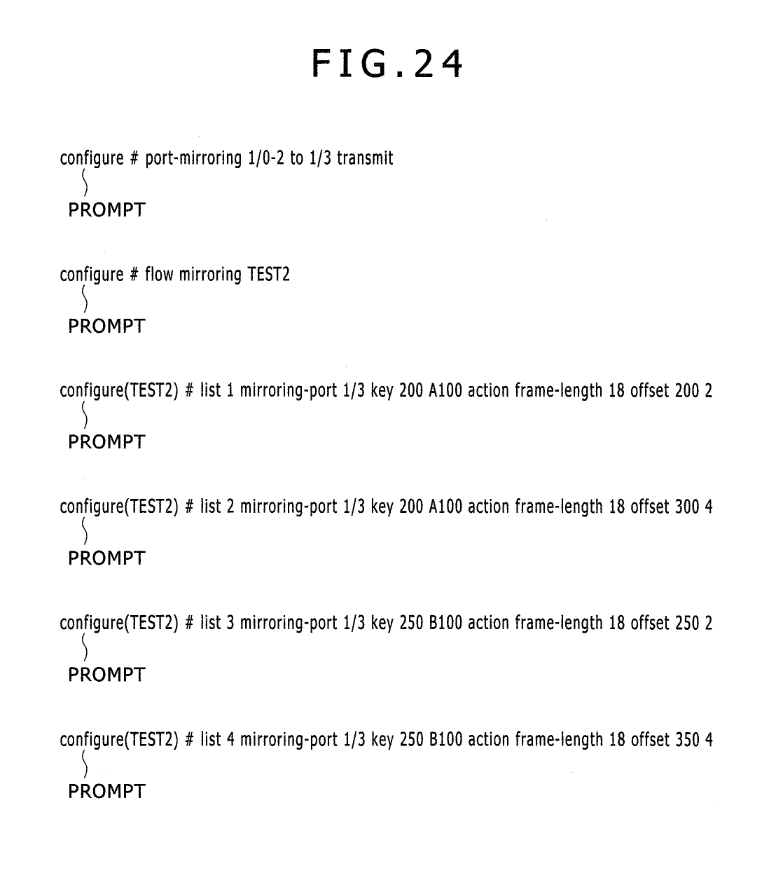

An eighth embodiment will be described with reference to FIGS. 20 to 24 and FIG. 2. FIG. 20 is a block diagram explaining a configuration of an operation ID management system. FIGS. 21A to 21C show formats of Ethernet frames used in the operation ID management system. FIG. 22 is a diagram explaining still another packet copy condition table. FIG. 23 is a diagram explaining an analyzer flow list. FIG. 24 is a diagram explaining an input command to an SW.

In FIG. 20, an operation ID management system 2000 includes an operation ID management system controlling server 300I, four SWs 100, an operation ID management server 300A of a company A, an operation ID management server 300B of a company B, an operation ID management server 300C of a company C, networks 106 connected to the servers, and an analyzer 108 connected to an SW 100-7.

The operation ID management server 300A is connected to a port 0 of the SW 100-7 through a network 106-4 and an SW 100-8. The operation ID management server 300B is connected to a port 1 of the SW 100-7 through a network 106-5 and an SW 100-9. The operation ID management server 300C is connected to a port 2 of the SW 100-7 through a network 106-6 and an SW 100-10. The analyzer 108 is connected to a port 3 of the SW 100-7. The operation ID management system controlling server 300I is connected to a port 4 of the SW 100-7. A management terminal 150 is further connected to the SW 100-7.

In the Ethernet frames used in the operation ID management system 2000 in FIGS. 21A to 21C, for the operation ID management server 300A of the company A, a 2-byte corporate discrimination ID code is added at the position apart from the top (MAC header) of the packet by 200 bytes, and a 4-byte personal discrimination ID code is added at the position apart from the top of the packet by 300 bytes, as shown in FIG. 21A. As similar to the above, for the company B, the 2-byte corporate discrimination ID code is added at the position apart from the top of the packet by 250 bytes, and the 4-byte personal discrimination ID code is added at the position apart from the top of the packet by 350 bytes, as shown in FIG. 21B. In FIG. 21C, the frame format of the copy packet has a total of 64 bytes including the 14-byte MAC header, the 2-byte corporate ID, the 4-byte personal ID, a 40-byte padding, and a 4-byte FCS3 computed using the MAC header, the corporate ID, the personal ID, and the padding.

A packet copy condition table 113F mounted in the SW 100-7 will be described with reference to FIG. 22. In FIG. 22, fields of a KEYLOC 612 and a KEYWORD 613 are newly added in place of the flow number 601, as apparent from comparison with the packet copy condition table 113C in FIG. 12.

For each input packet, a field located at the position apart from the top by the length defined in the KEYLOC 612 is referred to. If the field corresponds to the value defined in the KEYWORD 613, the packet is copied. On the contrary, if the field does not correspond to the value, the packet is not copied.

As the corporate discrimination ID of the company A and the corporate discrimination ID of the company B, “A100” and “B100 are assigned, respectively, in the eighth embodiment. FIG. 22 shows the packet copy condition table 113F for collecting the corporate discrimination IDs and the personal discrimination IDs of the company A and the company B.

In the packet length 603, 18 bytes obtained by adding the 14-byte MAC header to the 4-byte FCS is defined. Even if the 2-byte corporate discrimination ID and the 4-byte personal discrimination ID are added, the packet length of the copy packet is shorter than 64 bytes that is the shortest packet length of the Ethernet frame. Thus, the 40-byte padding data is added at the end of the personal discrimination ID data in the copy packet shown in FIG. 21C. It should be noted that if it is not necessary to add data relating to the frame header to the copy packet, 0 byte can be defined in the packet length 603. If the packet length is shorter than 64 bytes, the padding data is added at the end of the copy data.

Referring to FIG. 2 again, operations of the transfer unit 102 and the control unit 104 in the eighth embodiment will be described. In FIG. 2, the memory control unit 109 of the transfer unit 102 includes the memory reading management table 201. In addition, the copy condition table 113 of the control unit 104 includes the received-packet copy condition table 202 and the transmission-packet copy condition table 203. The data analyzing unit 110 analyzes the control information of each packet while referring to a header field of each packet input from the ports 0 to 2. The data analyzing unit 110 notifies the control unit 104 of the analysis result. Packet data pieces themselves are stored into the memory 101 from the data analyzing unit 110 through the memory control unit 109.

The control unit 104 allows the control information comparing unit 114 to compare the analysis result of the control information notified from the transfer unit 102 with the copy condition table 113. When the received packet is copied, the control unit 104 refers to the received-packet copy condition table 202 on the basis of a reception port number and a flow number notified from the data analyzing unit 110. On the other hand, when the transmission packet is copied, the control unit 104 refers to the transmission-packet copy condition table 203 on the basis of a transmission port number and a flow number determined by the control unit 104. The control unit 104 notifies the memory control unit 109 of the analysis result such as “copy or not”, “packet length” and “destination” indicated in a line corresponding to the reception port number or the transmission port number.

Specifically, the data analyzing unit 110 refers to the header of the packet received from the reception processing unit to analyze the control information. The data analyzing unit 110 transmits the analysis result and the packet to the control unit 104 and the memory control unit 109, respectively. The control unit 104 obtains a search condition from the copy condition table, and transmits the search condition to the memory control unit 109. The memory control unit 109 refers to the packet received from the data analyzing unit 110 to analyze on the basis of the search condition. The memory control unit 109 generates a record of the copy packet whose length is shortened in a memory calling management table on the basis of the analysis result.

In FIG. 23, an analyzer flow list 240 collected by the analyzer 108 includes a corporate ID 241, a personal ID 242, and a frame count 243. On reception of a mirror packet, the analyzer 108 searches the analyzer flow list 240 using the corporate ID 241 and the personal ID 242 as search keys, and increments the frame count 243 of the corresponding record.

With reference to FIG. 24, there will be explained a command input to the management terminal when an administrator of the SW 100-7 sets the table shown in FIG. 22. In FIG. 24, “configure #” in the first line is a prompt. “Port-mirroring 1/0-2 to 1/3 transmit” defines a slot number and a port number of an original port in mirroring and a slot number and a port number of a destination port in mirroring. A file name of “TEST2” is defined in the second line. “Configure (TEST2) #” in each of the third and fourth lines is a prompt. “Mirror-port 1/3” is defined as each of “list1” and “list2” for a destination port in mirroring. When “A100” is found at the position apart from the top by “200” bytes, a 14-byte field ranging from the top to the position obtained by subtracting 4 bytes from 18 bytes of the frame length, a 2-byte field from the position of “offset 200” bytes, and a 4-byte field from the position of “offset 300” bytes are copied. Even if the 4-byte FCS is added, the length of the copy frame is shorter than 64 bytes. Thus, the 40-byte padding is added, and the 4-byte FCS is further added for transfer. As “list1” and “list2”, if the destination port in mirroring (mirror-port 1/3) is identical to the flow search condition (if “A100” is found at the position apart from the top by “200” bytes), the copy frames are integrated to one frame, the value defined in the “frame-length” is available only for the list1 that is registered first. Commands in the fifth and sixth lines are also executed in the same manner as the above.

According to the eighth embodiment, mirroring conditions can be defined for packet data.

According to the present invention, the copy packet is output from the port where the copy packet is output while eliminating data portions that are unnecessary for traffic monitoring, thus enabling the traffic monitoring at a higher bandwidth than that at the port from which the copy packet is output. In addition, the number of ports for outputting the copy packets is small in the case of regarding as an apparatus, thus leading to less impact on the normal transfer.

What is claimed is:

1. A packet transfer apparatus which transfers a received packet, said apparatus comprising means for copying the received packet or a transmission packet,
wherein said means for copying copies an original packet by eliminating a part of the original packet and shortening the length of the packet.

2. The packet transfer apparatus according to claim 1, further comprising means for determining the length of the copy packet on the basis of control information of the original packet.

3. The packet transfer apparatus according to claim 1, further comprising a line load monitoring unit in a transmission processing unit.

4. The packet transfer apparatus according to claim 2, further comprising a line load monitoring unit in a transmission processing unit.

5. The packet transfer apparatus according to claim 3,
wherein said length of the copy packet is determined on the basis of a load-monitored result obtained by the line load monitoring unit.

6. The packet transfer apparatus according to claim 4,
wherein said length of the copy packet is determined on the basis of a load-monitored result obtained by the line load monitoring unit.

7. The packet transfer apparatus according to claim 1,
wherein each copy packet is given a priority order, and there is provided means for controlling output of the copy packet on the basis of the priority order.

8. The packet transfer apparatus according to claim 1,
wherein an eliminating portion of the original packet is determined depending on data of the received packet.

9. A packet transfer apparatus, comprising:
a reception processing unit;
a transfer unit including a data analyzing unit and a memory control unit; and
a control unit that holds a copy condition table and has a control information comparing unit,
wherein said data analyzing unit refers to a header of a packet received from the reception processing unit to analyze control information and transmits an analysis result to the control unit,
said control unit searches the copy condition table on the basis of the analysis result and transmits a search result to the memory control unit, and
said memory control unit generates a record of a copy packet whose packet length is shortened in a memory calling management table on the basis of the search result.

10. The packet transfer apparatus according to claim 9, further comprising a transmission processing unit including a line load monitoring unit,
wherein the length of the copy packet is determined on the basis of a load-monitored result obtained by the line load monitoring unit.

11. A packet transfer apparatus, comprising:
a reception processing unit;
a transfer unit including a data analyzing unit and a memory control unit; and
a control unit that holds a copy condition table and has a control information comparing unit,
wherein said data analyzing unit refers to a header of a packet received from the reception processing unit to analyze control information and transmits an analysis result and the packet to the control unit and the memory control unit, respectively,
said control unit obtains a search condition from the copy condition table and transmits the search condition to the memory control unit, and
said memory control unit analyzes the packet received from the data analyzing unit on the basis of the search condition and generates a record of a copy packet whose packet length is shortened in a memory calling management table.

12. A method for transmitting a copy packet, comprising:
a step of referring to a header of a received packet to analyze control information;
a step of searching a copy condition table on the basis of an analysis result;
a step of generating a record of a copy packet whose packet length is shortened in a memory calling management table on the basis of a search result; and
a step of transmitting the copy packet.

13. A method for transmitting a copy packet, comprising:
a step of referring to a copy condition table to obtain a search condition;
a step of referring to a received packet on the basis of an obtained result to obtain a search result under the search condition;
a step of generating a record of a copy packet whose packet length is shortened in a memory calling management table on the basis of the search result; and
a step of transmitting the copy packet.
